(19) United States
(12) Patent Application Publication
(10) Pub. No.: US 2012/0169037 A1
(43) Pub. Date: Jul. 5, 2012

(54) SHOPPING ORGANIZER FOR COUPONS AND BAR CODE BEARING CARDS

(76) Inventor: Richard J. White, III, Athens, GA (US)

(21) Appl. No.: 12/982,977

(22) Filed: Dec. 31, 2010

(51) Int. Cl. B42D 17/00

(52) U.S. Cl. 281/45

(57) ABSTRACT

A shopping organizer is provided that includes a front cover, a back cover, a front inner flap, and a back inner flap. A compartment for retaining individual printed media carriers such as coupons is formed by the front cover and the front inner flap so that storing and carrying loose coupons is facilitated. The shopping organizer also includes a plurality of berths, each berth for retaining a “key chain” type of bar coded card or for retaining a “wallet card” type of bar coded card. The shopping organizer can optionally include a pen retaining loop, a writing pad for writing down a shopping list, and a calculator. The shopping organizer is foldable to a smaller carry size in which the card berths are interleaved between the front and back covers.

### BACKGROUND OF THE INVENTION

The present invention relates to a shopping organizer and to a method of conveniently storing and carrying coupons and bar code bearing cards and for accessing such coupons and bar code bearing cards during a shopping experience.

Coupons for obtaining reduced prices for various goods and services are distributed to encourage prospective purchasers to purchase a given item or service at a discounted price or with the inclusion of a premium. Coupons are distributed by publishing them in newspapers, magazines and other media. Coupons are distributed via individual mailers with a single coupon or in a coupon package that includes a number of coupons. Coupons also readily are available via the internet, whereby a coupon can be downloaded and printed by an individual. Coupons are often collected in a stack by an individual. The coupons may be from many different products and services; some coupons may be redundant, e.g., for the same product with the coupons having a limitation of one per product or per shopping trip, etc. Sometimes coupons are expired or soon-to-expire, and, of course it is desirable to facilitate use of a soon-to-expire coupon before expiration to obtain maximum advantage of coupon collection efforts of that individual. It is easy to accumulate many coupons over a relatively short period of time, but it is difficult and time consuming to sort the coupons to facilitate timely use of the coupons and maximum advantage of use. Sometimes two coupons may be obtained for a given product; the coupons may be for different values to the individual user, usually it is advantageous to use the coupon that has the higher value to achieve maximum price discount.

Coupon organizers have been offered commercially that are operable to hold a stack of coupons. However, each time an individual wants to use a coupon, the individual must rifle through the coupons in the wallet to find a desired coupon. Sometimes a user may take a shopping cart filled with groceries to the checkout counter and then scan through the coupons in a stack of them contained in a wallet to try to find those coupons that may be applicable to the goods in the shopping cart. This takes time and leads to inconvenience for the coupon user and others who prefer not to spend time standing in line behind such a coupon user. Moreover, it is easy to miss a pertinent coupon as the coupons hastily are reviewed. Additionally, according to U.S. Pat. No. 3,911,605, coupons giving shoppers discounts on specified goods during limited time intervals have become commonplace as have the attendant check-out lane delays while shoppers sort through coupons which are obsolete, applicable to goods not actually purchased, good only in some future time period, or good only at some other store. Attempts to solve this storage and handling problem have primarily involved paper clips and rubber bands.

According to U.S. Pat. No. 7,353,996, a bar code may simply be comprised of an array of bars and spaces that represent numbers, letters, or other symbols, though the definition of bar code has been expanded to encompass two dimensional arrays of bars, dots and spaces. A bar code reader is used to read the code. The reader uses a laser beam and detector that is sensitive to the reflections from the line and space thickness and variations. The reader translates the reflected light into digital data that is transferred to a computer for immediate action or storage. Alternatively, an LED (Light Emitting Diode) may be used instead of a laser, to illuminate the bar codes. Still further, line scanners, CCDs (Charge Coupled Devices), and cameras may be used to read or scan bar code labels. Bar codes and readers are most often seen in supermarkets and retail stores, but are also used to take inventory in retail stores and to tabulate the results of marketing efforts.

A prevalent use of bar codes today is in the field of consumer tracking, such as in grocery stores, and unique member identification numbers for clubs such as health clubs, video store memberships, library memberships, and frequent-purchase clubs and programs. Accordingly, each of these locations provides the customer with an individualized bar code identification card, which the customer must have present in order to access the facility, participate in activities therein, or receive particular benefits. Every program in which the customer participates increases the number of cards that the individual must carry to ensure entry into the health club or discount warehouse, to be able to check out books or videos, and to be eligible for the lowest prices at the supermarket or “loyalty card” frequent-purchase program. Typical cards are either credit-card size (sometimes called “wallet size”) or a smaller “keychain”-tag size. While such cards are small and thin, just a few of the cards greatly increases the bulk of a wallet or purse. Carrying a multiplicity of cards also increases the amount of time the customer must spend at the check-out counter to find the correct card. Often these cards look similar, and time can be wasted if the customer presents the incorrect card. The customer may also be less inclined to join a frequent-purchase club or other type of club simply because they do not want to receive yet another membership card.

### SUMMARY OF THE INVENTION

The present invention provides a shopping organizer comprising a front cover, a back cover, a front inner flap, and a back inner flap. The front cover, the back cover, the front inner flap, and the back inner flap are secured together to form an integral structure having a carry size as measured in a longitudinal direction and a lateral direction perpendicular to the longitudinal direction when the integral structure is disposed in a carry disposition and having an access size when disposed in an access disposition in which the integral structure is larger in at least one of its longitudinal and lateral dimensions than when it is disposed in its carry disposition. The shopping organizer also provides at least one compartment for retaining individual printed media carriers such as coupons and a plurality of berths, each berth for retaining at least one carrier having a machine readable indicia thereon and the berths retaining the respective carriers in a fixed orientation relative to the integral structure.

Another embodiment of the present invention provides the shopping organizer described above further comprising a writing surface component operable to record written indicia. The integral structure includes a writing surface securing element for securing the writing surface component thereto in a predetermined orientation. Additionally, this aspect of the present invention provides the shopping organizer comprising a writing instrument securing element for securing a writing instrument to the integral structure and including a calculator. The integral structure includes a securing element for securing the calculator to the integral surface. This embodiment of the shopping organizer also includes the integral structure formed of a sheet of flexible material that bends when the integral structure is moved between its carry disposition and its access disposition.

The present shopping organizer invention also provides an embodiment wherein a sheet of flexible material is formed by at least one of a plastic material, a leather material, or a synthetic material other than plastic and further comprises a writing surface component operable to record written indicia. The integral structure includes a writing surface securing element for securing the writing surface component thereto in a predetermined orientation. The shopping organizer invention also includes an aspect wherein the writing surface component is a pad having a plurality of writing sheets and the pad is removably secured to the front cover. The front cover and the front inner flap are secured to each other to form a pocket operable as the at least one compartment for retaining individual printed media carriers in which individual printed media carriers such as coupons can be retained. The shopping organizer further comprises a zipper for releasably securing the front cover and the back cover to one another in the carry disposition of the integral structure.

Another aspect of the invention provides the shopping organizer as described above, wherein first one of the plurality of berths is operable to retain a first type carrier having a footprint size as measured in a height direction and a width direction perpendicular to the height direction. A second one of the plurality of berths is operable to retain a second type carrier having a footprint size as measured in the height direction and the width direction that is different than the footprint size of the first type carrier. The first berth is operable to receive a first type carrier inserted therein in which the first type carrier has a machine readable indicia that extends in a scanning direction that is at a fixed relation to the height and width directions of the first type carrier. The first berth is operable to receive each first type carrier inserted therein in a manner such that a machine readable indicia on the first type carrier always extends in substantially the same fixed relation relative to the longitudinal and lateral dimensions of the first berth. The second berth is operable to receive a second type carrier inserted therein in which the second type carrier has a machine readable indicia that extends in a scanning direction that is at a fixed relation to the height and width directions of the second type carrier. The second berth is operable to receive each second type carrier inserted therein in a manner such that a machine readable indicia on the second type carrier always extends in substantially the same fixed relation relative to the longitudinal and lateral dimensions of the second berth.

### BRIEF DESCRIPTION OF THE DRAWINGS

For a more complete understanding of the embodiments of the present invention, reference is now made to the following descriptions taken in connection with the accompanying drawings in which:

FIG. 1 is a perspective view of the shopping organizer of the present invention in a partially folded condition;

FIG. 2 is a front perspective view of the front cover of the shopping organizer;

FIG. 3 is a front perspective view of the back cover and back inner flap of the shopping organizer;

FIG. 4 is a top perspective view of a retail store environment in which the shopping organizer can be deployed;

FIG. 5 is a perspective view of a portion of the shopping organizer; and

FIG. 6 is a perspective view of a scanner of a checkout counter of a retail store environment in which the shopping organizer can be deployed.

### DETAILED DESCRIPTION OF AN EMBODIMENT

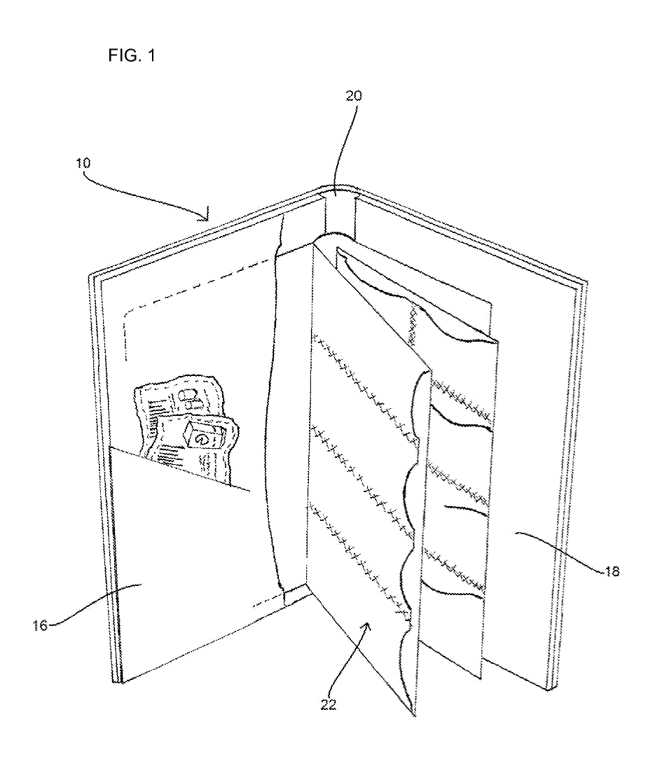

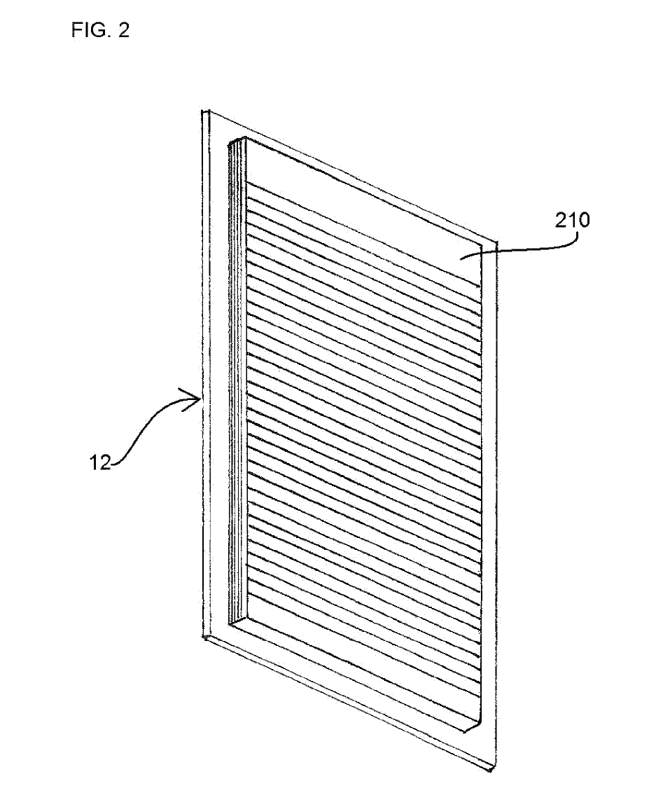

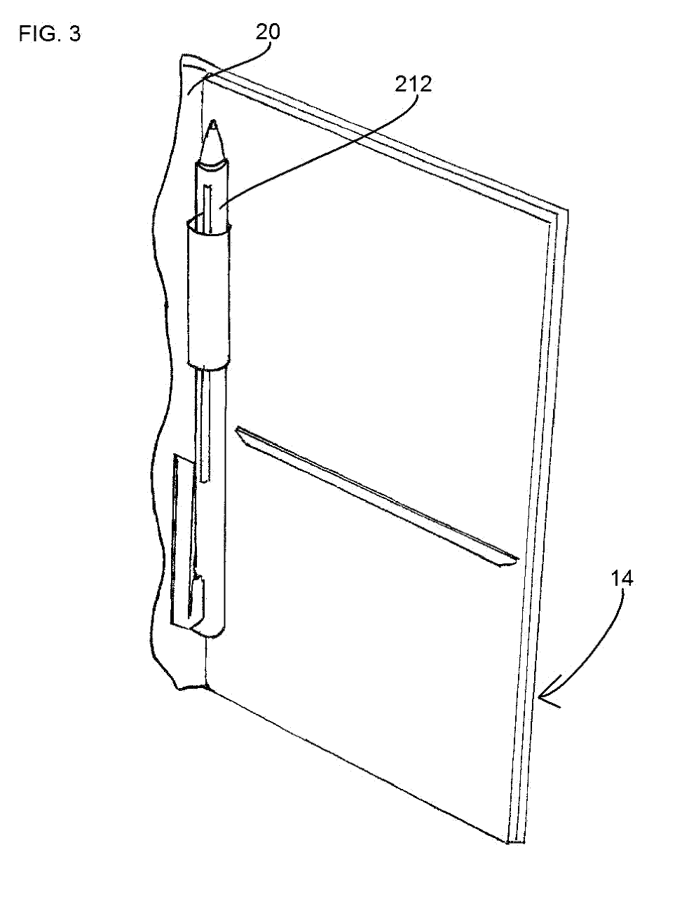

With reference now to FIGS. 1-6, details of the shopping organizer of the present invention, hereinafter designated as the shopping organizer 10, will be described, whereupon it will be seen that the shopping organizer is advantageously configured to store and carry coupons, indicia bearing cards such as, for example, cards bearing a bar code, and other items that make a shopping trip more convenient and organized. As seen in FIG. 1, which is a perspective view of the shopping organizer of the present invention in a partially folded condition, the shopping organizer 10 is configured to be folded between a carry condition, in which the shopping organizer is fully folded on itself, and a deployed condition, in which the shopping organizer has been unfolded to a degree to permit access to coupons and indicia bearing cards retained in the shopping organizer. As shown in FIG. 2, which is a front perspective view of the front cover of the shopping organizer shown in FIG. 1, the shopping organizer has a front cover side 12. As shown in FIG. 3, which is a front perspective view of the back cover and back inner flap of the shopping organizer shown in FIG. 1, the shopping organizer has a back cover 14. As seen in FIG. 1, the shopping organizer has a front inner flap 16, a back inner flap 18, and a binder spine 20 interconnecting the front inner flap 16 and the back inner flap 20 along respective adjacent longitudinal edges. The front cover 12, the back cover 14, the front inner flap 16, the back inner flap 18, and the binder spine 20 may be formed of a single piece of fabric cut and sewn to permit configuration of the shopping organizer as shown in FIGS. 1-3. Alternatively, each of the afore-mentioned cover and inner flap components can be separately fabricated and may be attached to one another via appropriate securement means such as, for example, stitching, adhesive, stapling, thermal joining, or any other suitable fabrication technique.

The shopping organizer 10 is formed of a parallelepiped configuration and is preferably configured as having a longitudinal dimension longer than its lateral dimension. Thus, for example, the lateral dimension of the shopping organizer 10 may be four and one half inches while the longitudinal dimension of the shopping organizer may be twice the lateral dimension—i.e., nine inches. The shopping organizer 10 is preferably dimensioned while taking into consideration to the capacity of the shopping organizer to store and carry coupons and/or bar code bearing cards, along with, if optionally provided, a writing pad, a writing implement, a calculator, or other components while also taking into consideration the desire that the shopping organizer 10 can be readily stored in, for example, a glove compartment of an automobile or other vehicle or in a drawer of a cabinet in a house. It can be understood that a configuration of the shopping organizer 10 in a manner that permits a relatively large volume of the coupons, the bar code bearing cards, and the other components to be stored will provide convenience as far as, for example, providing a convenient centralized storage for such items but such a configuration will increase the bulkiness of the shopping organizer and thereby detract from the ease of storing and carrying the shopping organizer.

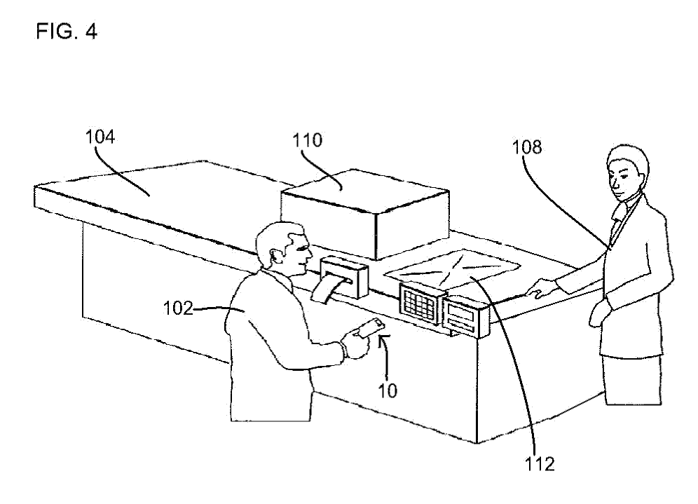

With reference now to FIG. 4, which is a top perspective view of a retail store environment, it can be seen that a customer 102 is standing on a customer side of a checkout counter 104 that operates as a location within a retail store at which customers pay for the store items. The customer 102 is holding the shopping organizer 10 in his hand for presentation to a sales employee 108 of the retail store. The sales employee 108 will use the shopping organizer 10, in a manner described in more detail below, to obtain and relay purchase information to a purchase control device (not shown) of the retail store, whereupon the customer 102 is able to complete a purchase of a store item 110. As will be described, the shopping organizer 10 conveniently permits a user such as the customer 102 to effect purchases without the need to remove a bar code bearing card from the shopping organizer during the purchasing transaction. Moreover, the shopping organizer 10 permits the customer 102 to have ready access to coupons retained in the shopping organizer. Both the coupons (if provided with a bar code indicia) and the bar code bearing cards can be scanned by a conventional bar code reader (not shown) by a swiping motion of the bar code indicia over a scanner window 112.

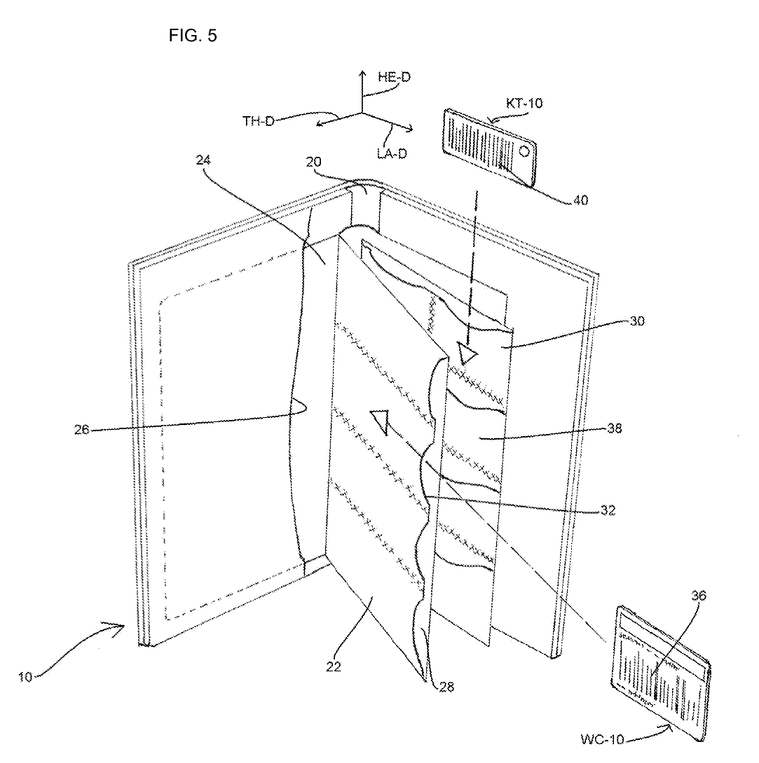

Reference is now had to FIGS. 1, 5, and 6 for a more detailed description of the configuration and operation of the shopping organizer 10. As seen in FIGS. 1 and 5, the shopping organizer 10 includes a leaf array 22 that is particularly advantageously configured for retaining and presenting bar code bearing cards. The leaf array 22 includes an anchor panel 24 that can be formed, for example, of a relatively stiff planar sheet of plastic, and the anchor panel 24 is configured to be inserted through a longitudinal slot 26 formed on the front inner flap 16 of the shopping organizer such that the leaf array 22 is reliably secured to the front inner flap 16. The leaf array 22 includes a wallet card leaf 28 specially configured to retain and orient a plurality of bar code bearing cards each in the form of a wallet card and a key tag leaf 30 specially configured to retain a plurality of bar code bearing cards each in the form of a key tag.

With continued reference to FIG. 5, each of the bar code bearing cards (which are in the form of a wallet card) are individually retained in the wallet card leaf 28 in a wallet card berth 32 having an opening compatibly configured with the dimension of each wallet card such that the wallet card can be conveniently inserted into the wallet card berth. The plurality of wallet card berths 32 may be formed, for example, on an integral sheet of plastic with each wallet card berth separated from an adjacent wallet card berth via, for example, a heat-formed barrier 34 and the wallet card leaf 28 is connected along an inner longitudinal edge to the anchor panel 24. Each wallet card such as, as seen in FIG. 5, a wallet card WC-10, is of a known longitudinal shape in which many so-called “loyalty” frequent-buyer cards are issued. The wallet card WC-10 has a bar code 36 imprinted thereon and extending along the longitudinal dimension of the wallet card. The key tag leaf 30 includes a plurality of key tag berths 38, each for individually receiving a key tag such as, for example, a key tag KT-10 as shown in FIG. 5 the key tag KT-10 is of a shape frequently used for so-called “key tag” loyalty cards provided to store customers and typically having a punched-out hole (not shown) via which a customer can secure the key tag to a key ring. The key tag KT-10 has a bar code 40 extending along a longitudinal extent of the key tag. The key tag KT-10 can be inserted into any selected one of the key tag berths 38 via movement of the key tag through a slot 42 provided in each respective key tag berth and each key tag berth 38 is compatibly configured with respect to the key tags such that the key tags are reliably retained in the key tag berth with the bar code 40 of each key tag oriented in a prescribed direction.

As seen in FIG. 5, the configuration of the wallet card leaf 28 and the key tag leaf 30 permits the wallet cards and the key tags to be inserted into their respective berths in a manner such that all of the bar codes provided on the wallet cards and the key tags are oriented in the same direction. That is, as explained with reference to the reference axes shown in FIG. 5, with the binder spine 20 of the coupon shopping organizer 10 extending in a height direction HE-D and, additionally, with the longitudinal edge of each of the wallet card leaf 28 and the key tag leaf 30 also extending in the height direction HE-D, the wallet card berths 32 operate to retain the wallet cards such as the wallet card WC-10 in a manner in which all of the bar codes 36 of these wallet cards extend perpendicularly to the height dimension HE-D along a lateral axis LA-D and, as well, the key tag berths 38 operate to retain the key tags such as the key tag KT-10 such that all of the bar codes 40 of the key tags extend as well along the lateral axis LA-D.

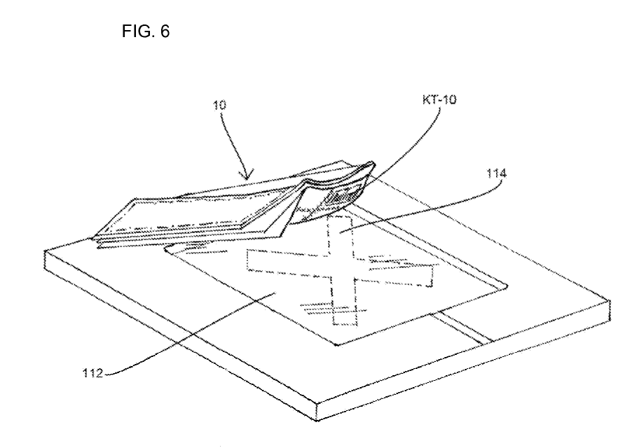

With reference now to FIG. 6, which is an enlarged perspective view of the shopping organizer shown in FIG. 1 deployed relative to a retail store scanner window, the shopping organizer 10 advantageously permits convenient and repeatable deployment of a wallet card or a key tag during a purchasing transaction. This convenience is provided by the afore-described orientation function performed by the leaf array 22 in orienting the bar codes 36 of the wallet cards and the bar codes 40 of the key tags. Thus, as seen in FIG. 6, a store employee such as the sales employee 108 shown in FIG. 4 can readily orient the shopping organizer 10 such that a selected bar code is easily positioned for a conventional scanning operation. As seen in FIG. 6, the scanner window 112 has a clear glass exposed area 114 in the shape of the letter “X” and the sales employee 108 need only swipe or transversely move the bar code 40 of the key tag KT-10, for example, generally over the exposed glass area 114 to permit the scanning rays of the bar code reader to “read” the bar code 40. The sales employee 108 orients the shopping organizer 10 such that the shopping organizer is face down relative to the scanner window 112 and moves the shopping organizer in the scan direction SW-D, whereupon the bar code reader emits light beams through the exposed glass area 114 that illuminate or irradiate the bar code 40 of the key tag KT-10. Once the sales employee 108 confirms that the store's purchase control equipment has accurately registered the information provided via the bar code scanning transaction, the sales employee 108 returns the shopping organizer 10 to the customer 102.

Thus, it can be understood that the shopping organizer 10 provides a first berth (i.e., each of the wallet card berths 32) that is operable to receive a first type carrier inserted therein (i.e., the wallet card WC-10) in which the first type carrier has a machine readable indicia that extends in a scanning direction that is at a fixed relation to the height and width directions of the first type carrier and the first berth is operable to receive each first type carrier inserted therein in a manner such that a machine readable indicia on the first type carrier always extends in substantially the same fixed relation relative to the longitudinal and lateral dimensions of the first berth. Moreover, it can be understood that the shopping organizer 10 provides a second berth (i.e., each of the key tag berths 38) that is operable to receive a second type carrier inserted therein (i.e., the key tag KT-10) in which the second type carrier has a machine readable indicia that extends in a scanning direction that is at a fixed relation to the height and width directions of the second type carrier and the second berth is operable to receive each second type carrier inserted therein in a manner such that a machine readable indicia on the second type carrier always extends in substantially the same fixed relation relative to the longitudinal and lateral dimensions of the second berth.

The shopping organizer 10 can also be enhanced with other features that may be retained on or stored in the shopping organizer 10, such as, for example, a writing pad 210 (as seen in FIG. 2), a pen 212 (as seen in FIG. 3), or a calculator (not shown). The pad 210 may be formatted with a number of lines preprinted on it to facilitate writing a shopping list. The pad 210 is exemplary of one of the types of devices that may be of use to a person who carries the shopping organizer 10 with him or her during a shopping experience such as, for example, while a person is shopping in a supermarket or another retail store. The pad and pen may be used to write a shopping list; e.g., a list of goods to be purchased at a store. The calculator may be used to add prices and to determine the most cost effective purchasing routine, e.g., whether to purchase a large size of a given item or two of the smaller size packages of that item.

The teachings of this application are not to be construed as being limited to any particular system or method. While various embodiments of the invention have been described and illustrated herein, it is to be distinctly understood that the invention is not limited thereto, but may be otherwise variously embodied and practiced within the scope of the following claims.

It is claimed:

1. A shopping organizer comprising:
a front cover;
a back cover;
a front inner flap;
a back inner flap, the front cover, the back cover, the front inner flap, and the back inner flap being secured together to form an integral structure having a carry size as measured in a longitudinal direction and a lateral direction perpendicular to the longitudinal direction when the integral structure is disposed in a carry disposition and having an access size when disposed in an access disposition in which the integral structure is larger in at least one of its longitudinal and lateral dimensions than when it is disposed in its carry disposition;
at least one compartment for retaining individual printed media carriers such as coupons; and
a plurality of berths, each berth for retaining at least one carrier having a machine readable indicia thereon and the berths retaining the respective carriers in a fixed orientation relative to the integral structure.

2. The shopping organizer according to claim 1 and further comprising a writing surface component operable to record written indicia and the integral structure includes a writing surface securing element for securing the writing surface component thereto in a predetermined orientation.

3. The shopping organizer according to claim 2 and further comprising a writing instrument securing element for securing a writing instrument to the integral structure.

4. The shopping organizer according to claim 2 and further comprising a calculator and the integral structure includes a securing element for securing the calculator to the integral surface.

5. The shopping organizer according to claim 1, wherein the integral structure is formed of a sheet of flexible material that bends when the integral structure is moved between its carry disposition and its access disposition.

6. The shopping organizer according to claim 5, wherein the sheet of flexible material is formed by at least one of a plastic material, a leather material, or a synthetic material other than plastic.

7. The shopping organizer according to claim 6 and further comprising a writing surface component operable to record written indicia and the integral structure includes a writing surface securing element for securing the writing surface component thereto in a predetermined orientation.

8. The shopping organizer according to claim 7, wherein the writing surface component is a pad having a plurality of writing sheets and the pad is removably secured to the front cover.

9. The shopping organizer according to claim 8, wherein the front cover and the front inner flap are secured to each other to form a pocket operable as the at least one compartment for retaining individual printed media carriers in which individual printed media carriers such as coupons can be retained.

10. The shopping organizer according to claim 9 and further comprising a zipper for releasably securing the front cover and the back cover to one another in the carry disposition of the integral structure.

11. The shopping organizer according to claim 1, wherein first one of the plurality of berths is operable to retain a first type carrier having a footprint size as measured in a height direction and a width direction perpendicular to the height direction and a second one of the plurality of berths is operable to retain a second type carrier having a footprint size as measured in the height direction and the width direction that is different than the footprint size of the first type carrier.

12. The shopping organizer according to claim 11, wherein the first berth is operable to receive a first type carrier inserted therein in which the first type carrier has a machine readable indicia that extends in a scanning direction that is at a fixed relation to the height and width directions of the first type carrier and the first berth is operable to receive each first type carrier inserted therein in a manner such that a machine readable indicia on the first type carrier always extends in substantially the same fixed relation relative to the longitudinal and lateral dimensions of the first berth.

13. The shopping organizer according to claim 12, wherein the second berth is operable to receive a second type carrier inserted therein in which the second type carrier has a machine readable indicia that extends in a scanning direction that is at a fixed relation to the height and width directions of the second type carrier and the second berth is operable to receive each second type carrier inserted therein in a manner such that a machine readable indicia on the second type carrier always extends in substantially the same fixed relation relative to the longitudinal and lateral dimensions of the second berth.
